(19) United States
(12) Patent Application Publication
(10) Pub. No.: US 2013/0157133 A1
(43) Pub. Date: Jun. 20, 2013

(54) Process for Producing Defect-Free Lithium Metal Phosphate Electrode Materials

(71) Applicant: Brookhaven Science Associates, LLC, Upton, NY (US)

(72) Inventors: Jiajun Chen, Ridge, NY (US); Jason Graetz, Calverton, NY (US)

(73) Assignee: Brookhaven Science Associates, LLC, Upton, NY (US)

(21) Appl. No.: 13/676,916

(22) Filed: Nov. 14, 2012

Related U.S. Application Data
(60) Provisional application No. 61/561,058, filed on Nov. 17, 2011.

(51) Int. Cl. H01M 4/485

(52) U.S. Cl. CPC H01M 4/485
USPC 429/221; 429/231.1; 429/224; 429/231.3; 429/223; 429/231; 252/182.1; 252/519.14; 252/506

(57) ABSTRACT

A method of synthesizing defect-free phospho-olivine materials is disclosed. The method is based on direct hydrothermal synthesis of phospho-olivine compound(s) and subsequent lattice reordering at or near the transition temperature to eliminate lattice defects or on one-pot in situ hydrothermal synthesis of phospho-olivine compound(s), where the cation ordering occurs during dwell time after rapid synthesis to eliminate lattice defects. The disclosed methods produce defect-free phospho-olivine compound(s) having a crystal lattice with a Pnma space group. In order to determine the exact transition temperature for complete removal of single- or mixed-transition metals from lithium sites or to monitor the crystal growth and removal of single- or mixed-transition metals from lithium sites during the hydrothermal synthesis, the method encompasses a procedure for determining and monitoring defects in the phospho-olivine phases using X-ray diffraction.

### CROSS-REFERENCE TO A RELATED APPLICATION

This application claims the benefit under 35 U.S.C. 119(e) of U.S. Provisional Application No. 61/561,058 filed on Nov. 17, 2011, the content of which is incorporated herein in its entirety.

### STATEMENT OF GOVERNMENT LICENSE RIGHTS

The present invention was made with government support under contract number DE-AC02-98CH10886 awarded by the U.S. Department of Energy. The United States government may have certain rights in this invention.

### FIELD OF THE INVENTION

This invention relates to the field of lithium ion batteries, and especially positive electrode materials for lithium ion batteries. In particular, the invention relates to a method of synthesizing defect-free phospho-olivines by a combination of hydrothermal chemistry and lattice reordering at or near the transition temperature of defect elimination.

### BACKGROUND

Present-day Li-ion battery technology offers promise for meeting the electrical energy storage demands for both mobile and stationary applications and olivine-phase lithium metal phosphates have been extensively studied as promising cathode materials to be used in the Li-ion battery systems. This material has a high specific capacity, excellent thermal stability, and stable cyclability (Padhi, A. K.; et al., J. Electrochem. Soc. 1997, 144 (4) 1188-1194, incorporated herein by reference in its entirety).

LiFePO₄, for example, adopts an olivine structure with a Pnma space group, where lithium is contained within the tunnels of interconnected FeO₆ octahedra and PO₄ tetrahedra. The Pnma structure is stable over the full range of lithium concentrations (0≦x≦1), and therefore all of the lithium ions can be utilized in the electrochemical reaction. This is in contrast to layered metal oxides, in which only about half of the lithium can be removed from the structure. During electrochemical cycling, the olivine structure undergoes a volume change of only about 6.5% between lithiated LiFePO₄ and delithiated FePO₄, and therefore the material does not suffer significantly from particle decrepitation. Although the intrinsic conductivity of this material is low, it has been increased substantially by the addition of carbon coatings.

A key hurdle for the widespread commercialization of these materials is the development of an economical manufacturing process. A low-temperature, soft-chemistry route, such as hydrothermal synthesis, offers a low-cost and efficient process for the manufacture of these electrode materials. However, it has been found that the site mixing of the cations, e.g., lithium and iron, is a potential problem with materials synthesized by this method (Chen, J. J.; et al., Solid State Ionics 2008, 178 (31-32) 1676-1693, incorporated herein by reference in its entirety). Titanium disulfide (TiS₂), for example, has a perfect layered structure and weak van der Waals force between the layers that allows fast lithium intercalation and diffusion (Whittingham, M. S. Chem. Rev. 2004, 104 (10) 4271-4301, incorporated herein by reference in its entirety). However, the titanium atoms, when they are disordered, can occupy sites in the lithium layer when the synthesis conditions are not optimum. Thus, disordered titanium in the structure severely impedes the lithium-ion diffusion and reduces the electrochemical performance of TiS₂. Similar cases were also found in layered oxides and further described in Lu, Z. H. et al. (J. Electrochem. Soc. 2002, 149 (6) A778-A791), the disclosure of which is incorporated herein by reference in its entirety.

A key challenge with the Pnma structure is that lithium motion occurs through one-dimensional (1D) channels (along the b axis) and is unable to cross between channels because of a high activation barrier (Morgan, D. et al. Electrochem. Solid-State Lett. 2004, 7 (2), A30-A32, incorporated herein by reference in its entirety). Unlike the two-dimensional lithium diffusion that occurs in the layered metal oxides, the ions in LiFePO₄ are restricted and cannot move around blocked sites. Antisite defects (e.g., iron on lithium sites) are a critical problem for lithium diffusion because a single blocked ion in the channel prevents lithium-ion transport within that channel.

The octahedrally coordinated cations, lithium and iron, in the naturally occurring mineral triphylite, are completely ordered between the M1 and M2 sites. However, LiFePO₄ synthesized at low temperature (120° C.) was shown to have almost 7% iron occupancy on the lithium sites (Yang, S. F. et al., Electrochem. Commun. 2001, 3 (9) 505-508, incorporated herein by reference in its entirety). In this case, the reactivity of the material was significantly reduced, reacting with only a small amount of butyllithium and not at all with bromine. The electrochemical capacity of these samples measured at low current densities was also small (Yang, S. F. et al., J. Power Sources 2003, 119, 239-246, incorporated herein by reference in its entirety).

More recent research has shown that the hydrothermal reaction temperature is a critical factor in the formation of antisite defects in olivine metal phosphates (Chen, J. J. and Whittingham, M. S. Electrochem. Commun. 2006, 8 (5) 855-858, incorporated herein by reference in its entirety). For instance, the anti-site defects in hydrothermally prepared olivine metal phosphates can be eliminated by preparing the material at elevated temperature (>200° C.) or by including a post-synthesis, high temperature heat treatment (600-700° C.). (Whittingham, 2004 and Yang, 2003). However, a number of uncertainties still remain in optimizing the hydrothermal synthesis condition for the preparation of olivine metal phosphates. For example, it is still not known whether olivine metal phosphates are precipitated directly at elevated temperatures or formed after the solution has cooled.

Other issues remain including the general solubility of olivine metal phosphates at high temperatures during the reaction, the formation of intermediates between the reactant and product, crystal growth rate, and the amount of structural disorder in the final product. An especially important issue is the relationship between the concentration of defects (especially anti-site defects) and the temperature and time of synthesis. This relationship is normally determined by tedious, time-consuming Edisonian (trial-and-error) approach that typically results in wasted energy and starting materials. Both experimental and theoretical studies have shown that limiting the number of channel-blocking point defects (iron on lithium sites) is critical for the preparation of olivine metal phosphates suitable for lithium-ion batteries. Currently, little is known about how the defect concentration changes during synthesis and how to control it.

Thus, despite the availability of various methods of synthesizing phospho-olivine phases, there is still a need for a cost effective and efficient method that overcomes the shortcomings of previous methods. The shortcomings are for example, an unacceptable number of defects formed in the olivine structure and the efficient and cost-effective manner of removing these defects in order to produce lithium insertion-type electrodes.

### SUMMARY

A method of synthesizing substantially defect-free phospho-olivine compound(s) having a formula LiₓMPO₄, where 0<x≦1 and M is one or more of the following metals: Fe, Mn, Co, Ni, Mg, and Zn, is disclosed. The resulting phospho-olivines can either form macroscopic-, microscopic- or nanoscopic-structures composed of a substantially defect-free crystal lattice. A crystal lattice of phospho-olivine having less than about 2% defects is considered to be the substantially defect-free crystal lattice, and is referred to as “defect-free’ in the present specification.

In one embodiment, the method is based on direct hydrothermal synthesis of phospho-olivine compound(s) and lattice reordering of the produced compound(s) at or near their transition temperature to eliminate lattice defects, thereby producing defect-free phospho-olivine compound(s). In order to determine the exact transition temperature for complete removal of single- or mixed-transition metals from lithium sites, the method encompasses a procedure for determining and monitoring defects in the phospho-olivine phases using X-ray diffraction, for example, by utilizing a diffractometer.

Preferably, the method includes direct hydrothermal synthesis of phospho-olivine(s) by combining aqueous solutions of Li⁺, Mⁿ⁺, and PO₄³⁻ (where Mⁿ⁺ is a M-type precursor) in a reactor and heating the combination to about 100° C. to 350° C. under elevated pressure between about 100 and 3000 psi, for about 1 to 16 hours to initiate hydrothermal phospho-olivine crystal growth. The M-type (Mⁿ⁺) precursor can be one or more single or a mixed transition metal selected from Fe²⁺, Fe³⁺, Mn²⁺, Co²⁺, Ni²⁺, Mg²⁺, or Zn²⁺. Preferably, the molar ratio of Li⁺, Mⁿ⁺, and PO₄³⁻ during the hydrothermal synthesis is between about 1:1:1 to about 10:1:1 and more preferably about 3:1:1. A reducing agent, such as L-ascorbic acid, sucrose, hydrazine, or citric acid, can also be added to the solution of Li⁺, M⁺, and PO₄³⁻ to minimize Mⁿ⁺ oxidation.

After the completion of the crystal growth, the method further includes recovering the phospho-olivine produced as a powder by various techniques known in the art, such as filtration and drying. At this stage of synthesis, the phospho-olivine compound has varying degrees of defects defined by a presence of single- or mixed transition metals (M) in lithium sites of the lattice. The presence of single- or mixed transition metal (M) in lithium sites blocks diffusion of the lithium ions, which results in poor electrochemical properties. In accordance with the disclosed method, to insure ordering of the lithium and single- or mixed transition metals (M) in the lattice, the produced phospho-olivine powder is heat treated in an inert or reducing atmosphere near or at the transition temperature of defect elimination, which is determined by in situ x-ray diffraction. In a preferred embodiment, the transition temperature for defect elimination in the iron-based phospho-olivine (LiFePO₄) is about 450° C. to about 500° C.

In a further embodiment, the method is performed based on one-pot in-situ hydrothermal synthesis of phospho-olivine compound(s), preferably, in a sealed in situ hydrothermal reactor shown in FIG. 7. The reactor illustrated in FIG. 7 provides continuous rotation of the solution and real-time exposure to X-ray diffraction that monitors the formation and elimination of anti-site defects during hydrothermal synthesis. Rather than pre-pressurizing the reactor at room temperature, the reactor pressure is allowed to increase with temperature (autogenous pressure), which more closely resembles the conditions used in autoclaves (e.g., Parr reactor) during standard hydrothermal syntheses. The method includes combining aqueous solutions of Li⁺, Mⁿ⁺, and PO₄³⁻ to form a slurry and directly injecting the slurry into the sealed in situ hydrothermal reactor. The reactor is subsequently heated to a temperature of about 105° to 210° C. under autogenous pressure to initiate hydrothermal phospho-olivine crystal growth.

Without wishing to be bound by any particular theory, it is believed that the formation of phospho-olivine compound(s), such as LiFePO₄, occurs by a dissolution/reprecipitation process and is controlled by 3-D diffusion. In order to determine the exact transition temperature and dwell time for complete removal of single- or mixed-transition metals from lithium sites, the method encompasses real-time monitoring of the formation and elimination of anti-site defects during hydrothermal synthesis using X-ray diffraction, for example, using a diffractometer. Preferably, during synthesis of the defect-free phospho-olivine compound(s), the temperature is maintained at 105 to 210° C. for about 30 to 120 minutes. More preferably, the temperature is maintained at 155 to 195° C. for about 40 to 60 minutes. Thus, in this embodiment, the defect-free phospho-olivine compound(s) can be produced without post-synthesis, high temperature heat treatment. As in the first embodiment, the M-type (Mⁿ⁺) precursor can be one or more single or a mixed transition metal selected from the group consisting of Fe²⁺, Fe³⁺, Mn²⁺, Co²⁺, Ni²⁺, Mg²⁺, and Zn²⁺. Preferably, the molar ratio of Li⁺, Mⁿ⁺, and PO₄³⁻ in the precursors is between about 1:1:1 to about 10:1:1 and more preferably about 3:1:1. A reducing agent, such as L-ascorbic acid, sucrose, hydrazine, or citric acid, can also be added to the solution of Li⁺, Mⁿ⁺, and PO₄³⁻ to minimize Mⁿ⁺ oxidation.

The disclosed methods produce an abundance of high quality defect-free phospho-olivine macro-micro- or nano-crystal lattice compounds. Preferably, the phospho-olivine compound(s) form a lattice in the Pnma space group. The phospho-olivine compound can have a stable substoichiometric composition of LiₓMPO₄, where M can be selected from iron (Fe), manganese (Mn), cobalt (Co), nickel (Ni), magnesium (Mg), and zinc (Zn) or a combination thereof. The x subscript can be between 0 and 1, which means that all of the lithium ions can be utilized in the electrochemical reaction. Thus, the fractional subscripts will be omitted when referring to the phospho-olivine compounds for convenience. Accordingly, unless otherwise specifically indicated, for example, this disclosure will generally refer to LiₓMPO₄ for all x values between 0 and 1, instead of referring to, for example, Li_{0.5}MPO₄. In another exemplary embodiment, the phospho-olivine compound can be a composition with a formula Li-M1ₐ/M2_{b}/M3_{c}/M4_{d}/M5ₑ/M6_{f}-PO₄, where M1 . . . M6 are selected from Fe, Mn, Co, Ni, Mg, and Zn, but M1≠M2≠M3≠M4≠M5≠M6, such that 0≦a, b, c, d, e, f≦1 and a+b+c+d+e+f=1. In this embodiment, for example, Fe atoms in LiFePO₄ compound can be partly substituted by Mn atoms, thus producing a crystal having formula LiFeₐ/Mn_{b}PO₄, where a+b=1. It will be understood by those skilled in the art that other substitutions and additions of a M-type metal in the present phospho-olivine compound are foreseeable without departing from the scope of the disclosed invention.

The disclosed method further encompasses an electrode, preferably a cathode, composed of defect-free phospho-olivine compound(s) manufactured in accordance with the disclosed method combined with a conductive additive, such as a conductive carbon, and a binder. In a preferred embodiment, the composition of the phospho-olivine compound, additive, and binder is about 40% to 90% of the phospho-olivine compound, 10% to 50% of additive, and 5% to 25% of binder. In a more preferred embodiment the composition of the phospho-olivine compound, additive, and binder is about 55:30:15. The disclosed method further encompasses an electrochemical cell, i.e., a battery, having a cathode, an anode, and an electrolyte solution. In a preferred embodiment, the electrochemical cell is a lithium-ion battery having a cathode composed of a defect-free phospho-olivine compound manufactured in accordance with the disclosed method.

These and other characteristics of the phospho-olivine compound(s) and the method of synthesis will become more apparent from the following description and illustrative embodiments which are described in detail with reference to the accompanying drawings. Similar elements in each figure are designated by like reference numbers and, hence, subsequent detailed descriptions thereof may be omitted for brevity.

### BRIEF DESCRIPTION OF THE DRAWINGS

FIG. 1 shows a synchrotron X-ray diffraction (XRD) pattern and a Rietveld refinement of the hydrothermally prepared LiFePO₄. The inset shows the atomic structure of LiFePO₄, revealing the lithium tunnels.

FIG. 2A shows an in situ high-resolution synchrotron XRD pattern (scattering angle vs. intensity of FIG. 1) of hydrothermally synthesized LiFePO₄ as a function of heat treatment.

FIG. 2B shows an expanded region of the XRD pattern from FIG. 2A (2θ 5-7.5°) showing a shift of the peak position.

FIG. 3 is a plot that shows the change of lattice parameters a, b, and c as a function of temperature.

FIG. 4 is a plot that shows the change of unit cell volume and the concentration (percent) of iron on lithium sites as a function of temperature

FIG. 5 is a plot that shows electrochemical cycling discharge profiles of (a) LiFePO₄ before heat treatment and (b) after 500° C. heat treatment.

FIG. 6 illustrates the atomic structure of LiFePO₄ with Fe in the lithium tunnels, which disappears after heat treatment at the transition temperature.

FIG. 7 is an illustration of an in situ hydrothermal reactor

FIG. 8 is a plot of time-resolved XRD patterns during the transformation of Vivianite to LiFePO₄ at 105° C. (XRD patterns were collected continuously with about 1 min/pattern x-ray wavelength λ=0.7748 Å, beamline X14A, NSLS, BNL).

FIG. 9A is a plot that shows a comparison of a decay curve of precursor vivianite and a crystallization curve for LiFePO₄ formed at 105° C. and 115° C.

FIG. 9B is a plot that shows a crystallization curve for LiFePO₄ formed at 115° C. as extent of reaction and the calculated fits of the Avrami-Erofe'ev equation (bottom line) and 3-D diffusion (top line) to the data.

FIG. 10A is a plot that shows time-resolved XRD patterns of materials for the in-situ hydrothermal synthesis of LiFePO₄ heated from 100° C. to 160° C. XRD patterns were collected continuously with about 3.5 min/pattern x-ray wavelength λ=0.7748 Å, beamline X14A, NSLS, BNL.

FIG. 10B is an expanded region of XRD pattern (6-13° 2θ) of FIG. 10A that shows dissolution of Vivianite and the formation of LiFePO₄.

FIG. 11A is a plot that shows the concentration (percent) of iron on lithium sites as a function of scan number (from 155° C. to 210° C.) during in-situ hydrothermal synthesis.

FIG. 11B is a plot that shows the unit cell volume as a function of scan number (from 155° C. to 210° C.) during in-situ hydrothermal synthesis.

### DETAILED DESCRIPTION

The disclosed invention provides a new method of synthesizing defect-free phospho-olivine compound(s) having a formula (I),

LiₓMPO₄ (1)

where 0≦x≦1, and M can be one or more metals selected from iron (Fe), manganese (Mn), cobalt (Co), nickel (Ni), magnesium (Mg), or zinc (Zn), with iron (Fe) being preferred. It is to be understood that the defect-free phospho-olivine compound is the phospho-olivine compound having less than about 2% defects. In a preferred embodiment, it is even more desirable to have the phospho-olivine compound with less than about 0.5% defects. These phospho-olivines can either form macroscopic-, microscopic-, or nanoscopic-structures composed of a defect-free crystal lattice.

In a preferred embodiment, the method is based on direct hydrothermal synthesis of phospho-olivine compound(s) and subsequent lattice reordering (or cation ordering) at or near the transition temperature of lattice defects elimination, e.g., about 450° C. to about 500° C. for LiFePO₄, thereby producing one or more defect-free phospho-olivine compound(s) having a crystal lattice with a Pnma space group. While it is possible to eliminate lattice defects in the hydrothermally synthesized phospho-olivine compound(s) by heat treatment above the transition temperature, it is anticipated that overheating the phospho-olivines will undesirably impede the electrochemical performance of the manufactured phospho-olivine. Moreover, the heat treatment above the transition temperature would not be practical for large scale phospho-olivine production due to cost consideration and impracticality. In order to determine the exact transition temperature for complete removal of single- or mixed-transition metals from lithium sites, the disclosed method encompasses a procedure for determining and monitoring defects in the phospho-olivine phases using X-ray diffraction.

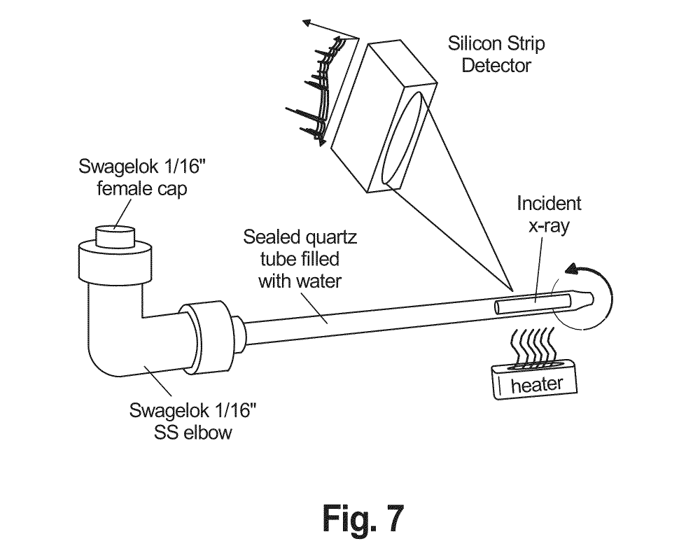

In another embodiment, the method is based on a one-pot in-situ hydrothermal synthesis of phospho-olivine compound(s) to eliminate lattice defects, thereby producing one or more defect-free phospho-olivine compound(s) having a crystal lattice with a Pnma space group. Preferably, the synthesis is done in a sealed in situ hydrothermal reactor shown in FIG. 7 that provides continuous rotation of the solution and real-time exposure to X-ray diffraction that monitors the formation and elimination of anti-site defects during hydrothermal synthesis. Without wishing to be bound by any particular theory, it is believed that the formation of phospho-olivine compound(s) occurs by a dissolution and reprecipitation process and is controlled by 3-D diffusion. Thus, in this embodiment, the defect-free phospho-olivine compound(s) can be produced without post-synthesis, high temperature heat treatment. It is to be understood, however, that those skilled in the art may develop other combinatorial, structural, and functional modifications and equivalents to the method of synthesizing phospho-olivines without significantly departing from the spirit and scope of the disclosed invention.

### I. Direct Synthesis

The disclosed method encompasses a method for synthesizing phospho-olivines-based compound(s) having a formula LiMPO₄ employing a combination of hydrothermal wet-chemistry and dry heat treatment at or near the transition temperature of lattice reordering. Hydrothermal synthesis has proven to be a cost-effective, energy-efficient approach for the manufacture of lithium phospho-olivines. However, hydrothermally prepared phospho-olivines typically suffer from antisite defects, where some of the metal atoms, such as Fe, Mn, Ni, Co, Zn, and Mg, reside on lithium sites and restrict lithium-ion mobility. As disclosed herein, the post-heat-treatment temperature at or near the transition temperature can be used to eliminate cation disorder in the manufactured phospho-olivines without overheating the phospho-olivines. It is believed that the disclosed method can significantly enhance electrochemical capacity within the defect-free phospho-olivine material.

The method includes preparing a phospho-olivine crystal lattice having a Pnma space group with a plurality of antisite defects. The method starts with a step of heating a combination of three precursors in a reactor, e.g., a Parr reactor: (1) a lithium precursor (Li⁺), (2) a phosphate precursor (PO₄³⁻) and (3) an M-type precursor (Mⁿ⁺), under slightly elevated temperature(s), i.e., 100° C. to 350° C., and pressure(s), i.e., 100-3000 psi, for a period of 1 to 16 hours, suitably 2 to 15 hours, preferably 3 to 10 hours, and more preferably 3 to 5 hours in order to initiate hydrothermal-type phospho-olivine crystal growth. Preferably, the combination of three precursors is heated under the temperature that ranges between 150° C. and 220° C. for a period of 3 to 5 hours under pressure of about 70 psi to 360 psi. Preferably, during heating, a reducing agent, such as L-ascorbic acid, sucrose, citric acid or hydrazine, can be added to minimize the M-type (Mⁿ⁺) precursor oxidation. However, other reducing agents, such as hydrazine, can also be used as long as these reducing agents minimize the precursor oxidation during the hydrothermal reaction.

The lithium precursor (Li⁺) may include, but is not limited to, LiOH, Li₂CO₃, Li₂SO₄, and LiH₂PO₄. The phosphate precursor (PO₄³⁻) may include, but is not limited to, H₃PO₄ and NH₄H₂PO₄. The M-type (Mⁿ⁺) can be one or more single or a mixed transition metals such as, Fe²⁺, Fe³⁺, Mn²⁺, Co²⁺, Ni²⁺, Mg²⁺, and Zn²⁺. The iron(II) precursor (Fe²⁺) may include, but is not limited to, FeSO₄.7H₂O, FeCl₂.4H₂O, FeCl₂, and FeC₂O₄. The iron(III) precursor (Fe³⁺) may include, but is not limited to, Fe(NO₃)₃. The manganese precursor (Mn²⁺) may include, but is not limited to, MnSO₄.H₂O, Mn(NO₃)₂ and MnCl₂. The cobalt precursor (Co²⁺) may include, but is not limited to, CoSO₄.7H₂O, CoCl₂.6H₂O, and Co(NO₃)₂. The nickel precursor (Ni²⁺) may include, but is not limited to, NiSO₄, Ni(NO₃)₂, and NiCl₂. The magnesium precursor (Mg²⁺) may include, but is not limited to, MgSO₄, Mg(NO₃)₂, MgCl₂. The zinc precursor (Zn²⁺) may include, but is not limited to, ZnSO₄, Zn(NO₃)₂, ZnCl₂. In a preferred embodiment, the molar ratio of Li, Mⁿ⁺, and PO₄³⁻ that can be used in the hydrothermal reaction is between about 1:1:1 to about 10:1:1; more preferably about 3:1:1. A typical concentration of Mⁿ⁺ can be between 10 to 50 g/L of water, with about 20 g/L being preferred. Thus, for every M-type precursor about 1 to 5 equivalents of the lithium precursor and about 1 equivalent of the phosphate precursor are used. After the completion of the phospho-olivine crystal growth, the method further encompasses recovering the produced phospho-olivine as a powder by various techniques known in the art, such as filtration and drying.

Alternatively, while the phospho-olivine compound can have a stable substoichiometric composition of LiₓMPO₄, where M can be selected from Fe, Mn, Co, Ni, Mg, and Zn, the phospho-olivine compound can also have a stable substoichiometric composition of Li-M1ₐ/M2_{b}/M3_{c}/M4_{d}/M5ₑ/M6_{f}-PO₄, where M1 . . . M6 are selected from Fe, Mn, Co, Ni, Mg, and Zn, but M1≠M2≠M3≠M4≠M5≠M6, such that 0≦a, b, c, d, e, f≦1 and a+b+c+d+e+f=1. In this alternative embodiment, for example, Fe atoms in LiFePO₄ compound can be partly substituted by Mn atoms, thus producing a crystal having formula LiFeₐ/Mn_{b}PO₄, where a+b=1. It will be understood by those skilled in the art that other substitutions and additions of a M-type metal in the present phospho-olivine compound are foreseeable without departing from the spirit and scope of the invention. For example, the synthesized phospho-olivine can be, but is not limited to, LiFe_{0.9}Mg_{0.1}PO₄, LiFe_{0.9}Zn_{0.1}PO₄, LiFe_{0.9}Zn_{0.1}PO₄, LiFe_{0.8}Zn_{0.2}PO₄, LiFe_{0.7}Ni_{0.3}PO₄, LiFe_{0.33}Mn_{0.33}Cu_{0.33}PO₄, LiMg_{0.5}Mn_{0.5}PO₄, LiMg_{0.1}Mn_{0.9}PO₄ and LiMg_{0.75}Mn_{0.25}PO₄.

In a preferred embodiment, in order to enhance the formation of nanoparticles of LiMPO₄ during the hydrothermal synthesis, an aqueous reaction medium can be substituted with a higher alcohol as described in Kim and Kim (Electrochem. Solid-State Lett. 2006, 9, A439), the disclosure of which is incorporated herein by reference in its entirety.

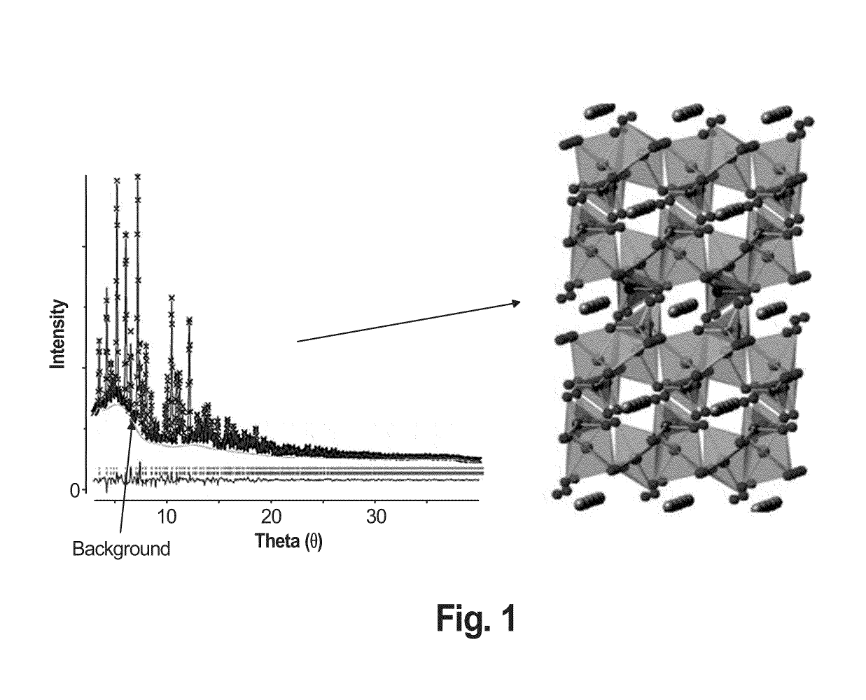

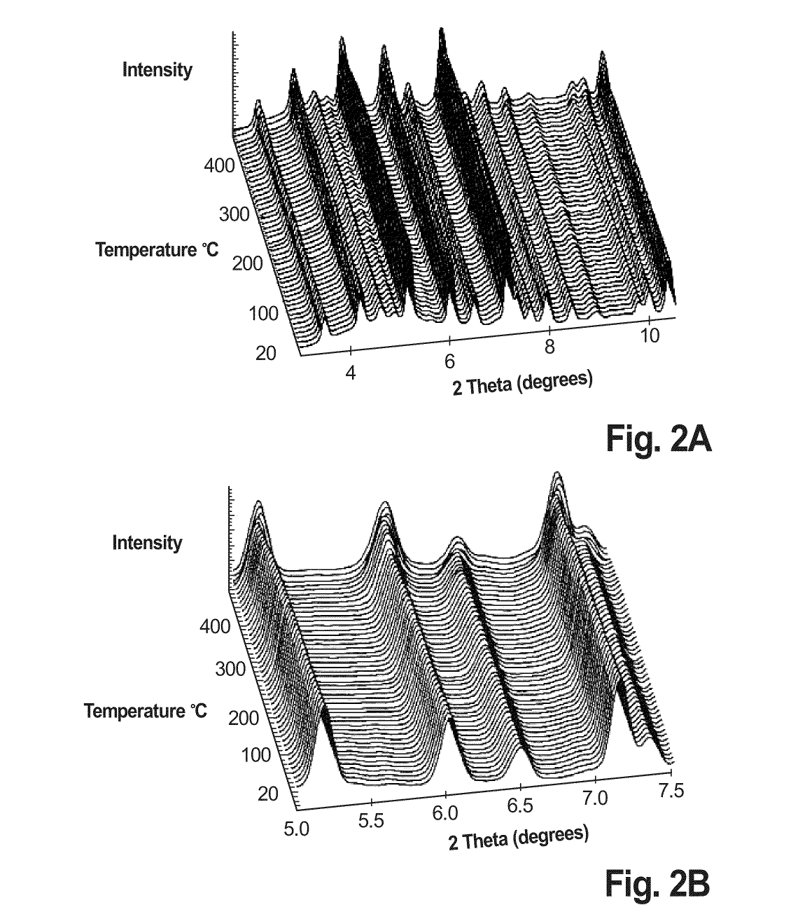

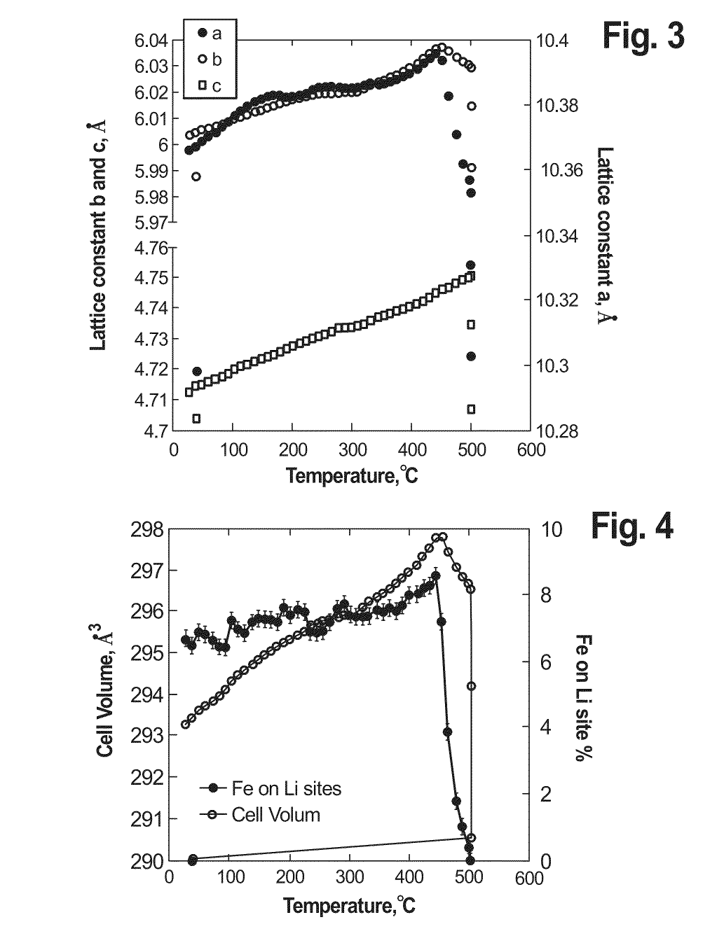

At this stage of synthesis, the produced phospho-olivine compound has varying degree of defects defined by a presence of M-type metals (M) in lithium sites of the lattice. The presence of M-type metals (M) in lithium sites block diffusion of the lithium ions, which results in poor electrochemical properties. To insure ordering of the lithium and M-type metals in the lattice, the hydrothermally synthesized phospho-olivine powder is heat treated in an inert or reducing atmosphere, e.g., Ar, N₂ and He, near or at the transition temperature, which is determined by in situ x-ray diffraction. It is believed that the transition temperature may change depending on the underlying conditions used during the hydrothermal synthesis. Thus, preferably, the transition temperature is determined for each set of parameters and conditions used before, during or after the hydrothermal synthesis, including, but is not limited to, the selection of precursors, temperature, pressure, duration, additives, volume, etc. The transition temperature can be obtained by (i) recording powder patterns of the Pmna phospho-olivine crystal (see e.g., FIG. 1 for LiFePO₄) and (ii) monitoring one or more lattice parameters a, b, and c (see e.g., FIGS. 2 and 3 for LiFePO₄). It is believed that a sudden drop in one or more of these lattice parameters indicates a transition temperature in lattice reordering, which signifies a defect elimination. Alternatively, the transition temperature can be obtained from monitoring a cell volume, i.e., V=a*b*c, where a sudden drop in cell volume indicates a transition temperature in lattice reordering (see. e.g., FIG. 4 for LiFePO₄). In yet another alternative, the transition temperature can be obtained from monitoring an electron density on the lithium site, i.e., site occupancy, where an increase in electron density indicates a transition temperature in lattice reordering. In a preferred embodiment, the transition temperature for defect elimination in the phospho-olivine having a formula LiFePO₄ is about 450° C. to about 500° C. (see FIG. 4; solid circles). Without being bound by any particular theory, it is believed that the defect-free phospho-olivine material produced after the second step, i.e., heat treatment, generally retains the shape of the phospho-olivine prepared after the first hydrothermal synthesis step. The defect-free phospho-olivine material produced after the second step exhibits only a small change in size with a volume contraction of 1-2% during the lattice reordering that eliminates M-type metals from the lithium sites. In addition, the disclosed process may produce an oxidized amorphous shell surrounding the crystal lattice of the LiMPO₄ material.

### II. One-Pot In-Situ Hydrothermal Synthesis

The disclosed method encompasses a method for synthesizing phospho-olivines-based compound(s) having a formula LiMPO₄ by employing a one-pot in-situ hydrothermal synthesis. Preferably, (1) a lithium precursor (Li⁺), (2) a phosphate precursor (PO₄³⁻) and (3) an M-type precursor (Mⁿ⁺) described in Section I (DIRECT SYNTHESIS) are combined to form a slurry and immediately injected into a sealed in situ hydrothermal reactor. A reducing agent can also be added to the solution to minimize Mⁿ⁺ oxidation. An example of the sealed in situ hydrothermal reactor is shown in FIG. 7. Rather than pre-pressurizing the reactor at room temperature, the reactor pressure is allowed to increase with temperature (autogenous pressure), which more closely resembles the conditions used in autoclaves (e.g., Parr reactor) during standard hydrothermal syntheses.

Preferably, the reactor provides continuous agitation of the slurry, for example, by rotation that ensures that the slurry is well mixed and the effects of preferred orientation are minimized. After the injection, the reactor is heated to a slightly elevated temperature to initiate hydrothermal-type phospho-olivine crystal growth and cooled after a period of dwell time once the defect-free phospho-olivines-based compound(s) are detected. The hydrothermal reaction temperature and dwell time may change depending on the conditions such as, but are not limited to, the selection of precursors, additives, volume, etc. Thus, it is preferable to monitor the crystal growth and defect elimination during synthesis of the phospho-olivines-based compound(s) and to adjust the temperature and time as required. According to this method, the defect-free phospho-olivine compound(s) can be produced without post-synthesis, high temperature heat treatment described in Section I (DIRECT SYNTHESIS) by precisely monitoring crystal growth and the anti-site defect elimination.

The crystal lattice phase formation and subsequent anti-site defect elimination can be determined by exposing the slurry to a real-time XRD monitoring system, such as a laboratory diffractometer (e.g., Rigaku MiniFlex™ II benchtop XRD system) or synchrotron light source (e.g., National Synchrotron Light Source at Brookhaven National Laboratory). The reaction temperature and dwell time are obtained by (i) recording powder patterns of the Pnma phospho-olivine crystal, (ii) monitoring one or more characteristic Bragg peaks to determine crystalline formation and (iii) monitoring one or more lattice parameters a, b, and c, or cell volume as a function of time and reaction temperature to determine the number of anti-site defects.

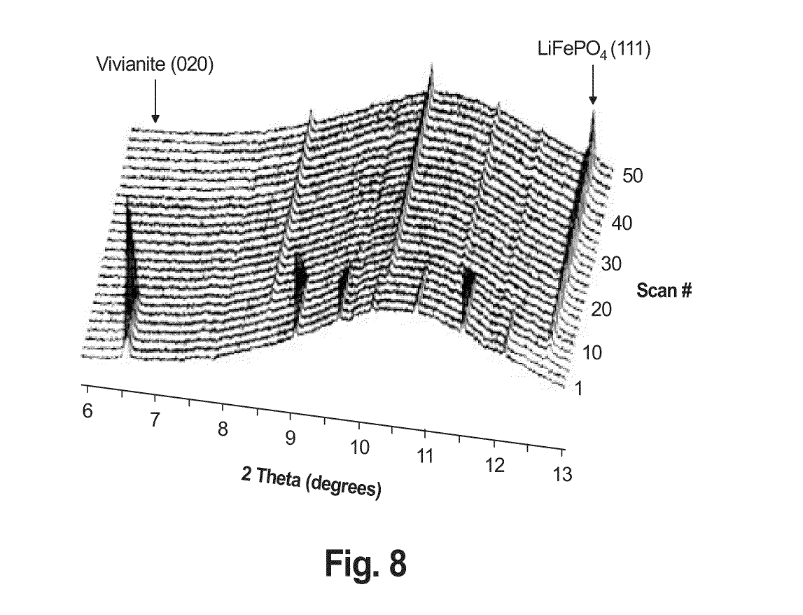

As illustrated in FIG. 8, a transition of characteristic Bragg peaks from one state to another state indicates the formation of the crystalline phospho-olivines-based compound(s). Typically, the transformation occurs within several minutes of the reaction, under the first reaction temperature above 100° C. Without wishing to be bound by any particular theory, it is believed that the formation of crystalline phospho-olivines-based compounds occurs by a dissolution—reprecipitation process and is controlled by 3-D diffusion. Since no obvious intermediate phases are formed during the synthesis, a rapid formation of phospho-olivines compound(s) under hydrothermal conditions at low temperatures is possible.

The newly formed crystalline phospho-olivines-based compounds may have a prohibitively large number of the anti-site defects, e.g., 5.1% for LiFePO₄ at 155° C. To eliminate or substantially reduce the number of anti-site defects, the crystalline phospho-olivines-based compounds are heated to a second temperature, which is necessary for lattice reordering and has the same effect as the post-synthesis transition temperature in direct synthesis approach (see Section I). The second reaction temperature can be obtained by monitoring the lattice parameters or cell volume, i.e., V=a*b*c determined from Rietveld refinement. The drop in the lattice parameters and/or cell volume indicates the onset of lattice reordering (or cation ordering), which signifies defect elimination (see. e.g., FIG. 12B for LiFePO₄). The dwell time, therefore, is the time until the defect concentration reaches a desirable level, e.g., below 2%, more preferable below 0.5%. An acceptable range for LiFePO₄ lattice reordering may be a dwell time of about 30 to 120 minutes at 105-210° C. Alternatively, the second reaction temperature can be obtained from monitoring the electron density on a lithium site, i.e., site occupancy, where an increase in electron density indicates a reaction temperature necessary for lattice reordering.

In a preferred embodiment, the second reaction temperature for defect elimination in the phospho-olivine having a formula LiFePO₄ is about 155° C. to about 210° C. (see FIG. 12A). Preferably the second reaction temperature for defect elimination in the phospho-olivine having a formula LiFePO₄ is about 155° C. and 195° C. More preferably, the second reaction temperature ranges between about 155° C. and 178° C. While the first and second reaction temperatures may differ, e.g., 105° C. and 155° C., the first and second reaction temperatures may also be the same or similar. Thus, if the second reaction temperature for defect elimination in the phospho-olivine having a formula LiFePO₄ is set to about 155° C. and 195° C., the first reaction temperature can be set to the same or about the same temperature, e.g., both may be set to 155° C. Thus, it is believed that given the low synthesis temperature, lack of costly and volatile solvents and the scalability of this process, this procedure can be well suited to the industrial-scale synthesis of high performance defect-free LiFePO4 for lithium batteries.

### III. Electrodes and Electrochemical Cells

As with most batteries, the electrochemical cell has an outer case made of metal or other material(s) or composite(s). The electrochemical cell is preferably a non-aqueous battery. The case holds a positive electrode (cathode), a negative electrode (anode), a separator, and an electrolytic solution. The separator is a very thin sheet of microperforated plastic, however, other materials may suitably be used to separate the positive and negative electrodes while allowing ions to pass through. The cathode is generally made from the defect-free phospho-olivine material(s), such as lithium iron phosphate (LiFePO₄) to produce the lithium insertion-type cathode, prepared or synthesized in accordance with the disclosed process. The anode is generally made from carbon. Both the anode and cathode are materials into which and from which lithium can migrate. When the battery charges, ions of lithium move through the electrolyte from the positive electrode to the negative electrode and attach to the carbon. During discharge, the lithium ions move back to the cathode from the anode. Inside the case, these sheets are submerged in an organic solvent that acts as the electrolyte. The electrolyte is composed of one or more lithium salts, one or more solvents and one or more anion receptors/additives.

Preferably, the cathode is composed of a defect-free phospho-olivine manufactured in accordance with the disclosed method, a conductive additive and a binder. In addition the cathode may include one or more lithium metal oxide compound(s). In particular, the cathode may comprise one or more defect-free lithium phospho-olivines with or without at least one other lithium mixed metal oxide (Li-MMO). Lithium mixed metal oxides contain at least one other metal selected from the group consisting of Mn, Co, Cr, Fe, Ni, V, and combinations thereof. For example the following lithium MMOs may be used in the cathode: LiMnO₂, LiMn₂O₄, LiCoO₂, Li₂Cr₂O₇, Li₂CrO₄, LiNiO₂, LiFeO₂, LiNiₓCo₁₋ₓO₂ (0<x<1), LiMn_{z}Ni_{1-z}O₂ (0<z<1; LiMn_{0.5}Ni_{0.5}O₂), LiMn_{0.33}Co_{0.33}Ni_{0.33}O₂, LiMc_{0.5}Mn_{1.5}O₄, where Mc is a divalent metal; and LiNiₓCo_{y}Me_{z}O₂ where Me may be one or more of Al, Mg, Ti, B, Ga, and Si and 0<x, y, z<1. Furthermore, transition metal oxides such as MnO₂ and V₂O₅; transition metal sulfides such as FeS₂, MoS₂, and TiS₂; and conducting polymers such as polyaniline and polypyrrole may be present. The preferred cathode material is the lithium phospho-olivine, such as LiFePO₄.

The cathode may further comprise a conductive additive. In a preferred embodiment, the conductive additive may be a conducting carbon, such as carbon black, e.g., super-P, or acetylene carbon. The cathode may also comprise a polymeric binder. In a preferred embodiment, the binder may be polyvinylidene fluoride, styrene-butadiene rubber, polyamide or melamine resin, and combinations thereof. In one embodiment, the composition of the phospho-olivine compound, conducting additive, and binder is about 40% to 90% of the phospho-olivine compound, 10% to 50% of additive, and 5% to 25% of binder. The preferred composition of the phospho-olivine compound, additive, and binder is about 55:30:15.

Although the preferred embodiment has been described with reference to lithium ion-based electrochemical cells, it is also envisioned that the present defect-free phospho-olivine materials can be successfully applied to other electrochemical cells, such as hybrid electrochemical cells (HEC), supercapacitors, fuel cells, and other conductors.

While the synthesized phospho-olivine materials and the structure of the electrochemical cells including electrodes based on such materials have been described in connection with what is presently considered to be the most practical and preferred embodiments, it is to be understood that the invention is not to be limited to the disclosed embodiments, but on the contrary, is intended to cover various modifications and equivalent arrangements included within the spirit and scope of the appended claims.

### EXAMPLES

The examples set forth below also serve to provide further appreciation of the disclosed invention, but are not meant in any way to restrict the scope of the invention.

### Example 1

The measurement of the concentration of antisite defects as a function of the temperature by in situ high-resolution XRD is provided to shed light on the defect elimination process during heat treatment. In situ observations of antisite defect elimination or creation are necessary to understand the defect formation and ultimately enhance the lithium-ion mobility in these materials by manipulating point defects.

High purity lithium iron phosphate was prepared by direct-hydrothermal synthesis in a Parr reactor (Chen, 2006). FeSO₄.7H₂O (98% Fisher), H₃PO₄ (85 wt. % solution Fisher), LiOH (98% Aldrich) were added to the reactor. A reducing agent L-ascorbic acid (Aldrich) was also added to minimize ferrous oxidation. The reactor was sealed and heated at 150-220° C. for 3 hour or 10 hours. The powder was recovered by filtration and dried under dynamic vacuum at 80° C. for several hours. The sample used for in-situ variable temperature powder X-ray diffraction (PXRD) was prepared at 180° C. for 3 hours.

### Example 2

The XRD samples were prepared by loading the fine powder into 0.5 mm quartz capillary tubes. The quartz capillary tubes were connected to a helium gas supply with a flow rate of 10 cc/min and heated by a resistive heating element. The temperature was measured with a thermocouple placed inside the capillary next to the sample. All of the data were collected on beam line X7B at the National Synchrotron Light Source (Brookhaven National Laboratory, Upton, N.Y.) using the NSLS-DAC software (Furenlid L. R. et al., J. Phys. IV France 7, 1997; C2-335-C2-336; incorporated herein by reference in its entirety). Powder patterns were recorded in the temperature range from 28° C. to 500° C. using an image plate area detector (Model MAR345) and an x-ray wavelength of 0.3184 Å. The distance between the sample and the detector (ca. 300 mm) and the tilt angle of the image plate relative to the beam were calibrated by a LaB₆ standard. The total time resolution of the experiment was 240 s (exposure time plus read-out time for the image plate) per powder pattern. The recorded images were subsequently converted to powder patterns using the FIT2D software package (http://www.esrf.eu/computing/scientific/FIT2D/). The sample was cooled down to room temperature and the powder XRD pattern was retaken in a new quartz capillary. The Rietveld refinements of the X ray powder diffraction patterns were carried out using the GSAS/EXPGUI package and the SeqGSAS utility was used to process all of the patterns sequentially.

The initial model of the crystal structure was adopted from Streltsov, V. A. et al. (Acta Crystallographica Section B-Structural Science 1993, 49, 147-153), the disclosure of which is incorporated herein by reference in its entirety. Strelsov et al. describe a multipole analysis of the electron density in triphylite, LiFePO₄, using X-ray diffraction data. The refinement performed as follows: first, the background and scale factor parameter were determined. The scale factor was refined and 20 background coefficients were used for a Chebyshev polynomial function. The subsequent steps included the Refine Zero parameter, unit cell dimensions and grain size parameters (X). After the initial refinement was stable (after several cycles), the other relevant parameters were released. First the atomic positions (coordinates) for the heavy atoms (Fe atom) were released and then slowly the light atoms (oxygen atom) were released. In the following refinement, atomic displacement parameters (Uᵢₛₒ) were released slowly in reverse order of atomic number. For oxygen atoms, the Uᵢₛₒ were grouped together for better accuracy due to the low scattering factor for each oxygen atoms. Finally the site occupancy factors were refined together along with atomic position and Uᵢₛₒ parameter. Due to the complexity of the in-situ heating cell, the LaB₆ calibration was performed in a separate ex-situ experiment. Therefore, all of the lattice parameters measured in the in-situ experiment were corrected by a constant value determined by LaB₆ ex-situ calibration. Representative refined atomic coordinates, atomic displacement parameters and site occupancies are shown in Table 1.

TABLE 1
Representative refined atomic coordinates, atomic
displacement parameters and site occupancies for LiFePO₄ crystal.

| Atom | x/a | y/b | z/c | Uiso | Occup. |
|---|---|---|---|---|---|
| Li1 | 0.0000 | 0.0000 | 0.0000 | 0.0213(27) | 0.9333(20) |
| Fe1 | 0.28139(12) | 0.25000 | 0.9760(4) | 0.00923 | 1.00 |
| Fe2 | 0.0000 | 0.0000 | 0.0000 | 0.0213(27) | 0.0667(20) |
| P1 | 0.09532(24) | 0.2500 | 0.4119(5) | 0.01074 | 1.00 |
| O1 | 0.1009(5) | 0.2500 | 0.7414(9) | 0.02052 | 1.00 |
| O2 | 0.4508(6) | 0.2500 | 0.2177(10) | 0.02052 | 1.00 |
| O3 | 0.1648(4) | 0.0434(7) | 0.2768(7) | 0.02052 | 1.00 |

LiFePO₄ prepared by the hydrothermal synthesis described in Example 1 had particles ranged in micrometer size. The particles were diamond-shaped platelets of 1-2 μm on edge. High-resolution synchrotron XRD was acquired over a wide 20 range (0.01-55°) using an X-ray wavelength of 0.3184 Å for both the ex situ and in situ samples. Approximately 4391 reflections were recorded, significantly larger than the number of peaks typically recorded on a laboratory Cu Kα powder X-ray diffractometer. The ex situ data were fit using GSAS Reitveld refinement over a 20 range of 3-55° with a Chebyshev polynomial function and 20 coefficients for the background. The full XRD patterns were perfectly indexed as orthorhombic with a Pnma space group, and no impurity peaks were observed. An example of the recorded XRD pattern is shown in FIG. 1 with the differences between the observed and calculated intensities plotted. All refinements from the ex situ samples terminated at reliability values of R_{wp}=2.3% and Rₚ=1.7%. A similar refinement was used for the in situ (variable-temperature) data, but the fit was restricted to a 2θ range of 3-25°, which included 482 reflections. No phase transformations were observed during heating because the material was heated under an inert atmosphere. All refinements from the in situ samples terminated at reliability values of around R_{wp}=2.6% and Rₚ=1.9%.

As illustrated in the inset of FIG. 1, in the olivine structure of LiFePO₄, both iron and lithium ions occupy octahedral sites, while phosphorus is in a tetrahedral site with a hexagonal close-packed structure. The distorted FeO₆ octahedron and PO₄ tetrahedron form tunnels through the structure (where the lithium resides), which restricts the lithium to 1D movement along the b axis.

### Example 3

Inductively coupled plasma optical emission spectrometry (ICP-OES) was conducted by Evans Analytical Group® (Syracuse, New York) to determine the chemical composition of the sample prepared in Example 1. Chemical analysis of the synthesized LiFePO₄ before heat treatment using ICP-OES revealed a significantly iron-rich sample with Fe:Li=1.49:1. This is consistent with previous reports that LiFePO₄ has a Fe:Li molar ratio of 1.41 (Liu, 2009) or LiMnPO₄ has a Mn:Li molar ratio of 1.31 (Fang, 2008) The high iron content determined by the ICP analysis suggests that it is unlikely that all of the excess iron is incorporated into the structure but rather that some of it likely resides on the surface. It is possible that some of the excess iron diffuses to the surface of the particles, where it forms a second phase (e.g., Fe₂O₃) that is not detected by XRD. Similar amorphous surface impurities have been reported by Shiraishi et al. (J. Power Sources 2005, 146 (1-2) 555-558; J. Electrochem. Soc. 2005, 152 (11) A2199-A2202; each incorporated herein by reference in its entirety).

### Example 4

Two crystallographic models are most likely for cation disorder in the samples prepared in Example 1, a lithium-iron mixing model (Li_{1-y}Fe_{y}[Li_{y}Fe_{1-y}]PO₄) and an iron-rich model (Li_{1-2y}Fe_{y}FePO₄). Refinements using both models were performed and found the best fits with the iron-rich model. This model is consistent with ICP-OES results, and was used for refinements of the site occupancy and to investigate the cation distribution. The iron (M2) 4c site occupancy was restricted to unity. Several trial refinements were carried out with the shared lithium site (4a) occupancy, initially set to different values (i.e., 0.95 and 0.9), to ensure the consistency of each refinement. The refinements were consistently refined to similar values, suggesting that the results are reliable.

### Example 5

Hydrothermally synthesized LiFePO₄ as provided in Example 1 with no heat treatment was determined to have around 6.7(2) % cation disorder, with the lithium octahedral M1 site (4a) containing 6.7(2) % iron. The structural formula was determined to be Li_{0.866}Fe_{0.067}FePO₄, with lithium vacancies for the charge compensation to high-valent iron(II). Previous studies of LiFePO₄ prepared by low-temperature synthesis have found excess iron on lithium sites in the range of 5-10% (Yang, 2001), which is consistent with our result of 6.7%. On the basis of the ICP results and the stoichiometry of Li_{0.866}Fe_{0.067}FePO₄, determined from Rietveld refinement, we find that antisite defects account for about half of the excess iron in the system. The remaining excess iron is likely present as an amorphous phase on the surface.

### Example 6

The measured lattice constants from synthesized LiFePO₄ in accordance with Example 1 before heat treatment were a=10.3658(6) Å, b=6.0037(3) Å, and c=4.7124(3) Å with a cell volume V=293.27(2) Å³, which is a slightly expanded cell dimension. The standard cell volume for defect-free LiFePO₄ is typically 291.4 Å³. The hydrothermally prepared sample used in this study had a defect concentration similar to that of LiFePO₄ single crystals (Li_{0.94}Fe_{0.03}FePO₄) formed hydrothermally at 180° C. for 3 h, as reported by Chen et al. (2008) but many more defects than materials synthesized at the same temperature for longer time. The organic acid and synthesis dwelling time were found to impact the concentration of defects.

### Example 7

A series of powder patterns were recorded over a temperature range between 28 and 500° C. using a ramping rate of 2.6° C./min. At the end of the ramp, the temperature was held constant at 500° C. for 10 min. In situ high-resolution synchrotron XRD patterns from hydrothermally synthesized LiFePO₄ during heating are shown in FIGS. 2A-2B. The anisotropic variation of the unit cell parameters is shown in FIG. 3. FIG. 3 further shows that upon heating to 450° C., all Bragg peaks shift to lower 20 angles, indicating an increase in the unit cell parameters due to thermal expansion. The a lattice constant was initially 10.3658(6) Å and increased up to 10.3954(9) Å at 443° C., while the b lattice constant was initially 6.0037(3) Å and gradually increased up to 6.0371(5) Å at a temperature of 453° C. In contrast, the c lattice constant continually increased from 4.7124(3) to 4.7501(6) Å until the temperature reached 500° C. The cell volume reached the highest value at 452° C. with cell dimensions of a=10.3934(9) Å, b=6.0371(5) Å, and c=4.7455(4) Å and a cell volume of 297.84(4) Å³.

The concentration of iron on lithium sites increases slightly with an increase in the temperature up to 442° C., as shown in FIG. 4. At 442° C., approximately 8.5(2) % of the iron remained on the lithium sites. The onset of cation ordering occurred around 450° C. At this transition temperature, all crystallographic reflections shift toward a higher 2θ angle, suggesting a decrease in the unit cell dimensions. The number of antisite defects abruptly dropped to essentially zero when the temperature reached around 500° C. The cell volume decreased to 290.46(4) Å³ after the temperature was held constant at 500° C. for 10 min. As the sample cooled to about room temperature (28° C.), the cell volume quickly decreased to 289.97(5) Å³. All of the standard deviation (σ) values for the refined site occupancies given by GSAS Expgui software are in the output data files were reported (see Chen et al (2011) ACS App Mater Interface, vol. 3, no. 5, pp. 1380-1384). The average of the refined atomic occupancy standard deviations is around 0.2%.

### Example 8

After heat treatment described in Example 7, the sample was resealed in a new quartz capillary tube, and another XRD pattern was acquired. LiFePO₄ exhibited a reduced lattice parameter at room temperature, with lattice constants a=10.303(1) Å, b=5.987(1) Å, and c=4.670(1) Å and a cell volume of 289.87(5) Å³. The reliability factors for this fit were R_{wp}=2.3% and Rₚ=1.8%. For micrometer-sized LiFePO₄, a unit cell volume of around 290-291.4 Å³ is believed to be a good measure of complete cation order (no iron on lithium sites), which is consistent with our results from hydrothermally prepared samples after heat treatment.

At temperatures above 450° C., the excess iron leaves the lithium sites. Although it is not clear from the data exactly where this excess iron goes, it does not seem to be incorporated into the structure and accommodated by other sites. It is possible that the excess iron diffuses to the surface of the particles, where it forms a second phase (e.g., Fe₂O₃). If this is the case, this other phase is composed of particles that are amorphous or too small to be detected by synchrotron XRD.

### Example 9

It is well-known that lithium-ion transport in LiFePO₄ occurs through the channels along the b direction (Nishimura, S. et al. Nat. Mater. 2008, 7 (9) 707-711, incorporated herein by reference in its entirety) and the substitution of even a small amount of Fe atoms onto Li sites blocks the channels and impedes lithium-ion transport. Complete lithiation or delithiation of disordered LiFePO₄ requires migration of point defects, which is a significantly slower step. Thus, the overall lithium-ion mobility and reactivity of the material is greatly reduced by iron disorder, as reported by Whittingham et al. (Electrochem. Commun. 2002, 4 (3) 239-244, incorporated herein by reference in its entirety). The elimination of iron disorder upon heat treatment allows unimpeded lithium-ion transport along the b direction and is essential to achieving the best possible electrochemical performance from hydrothermally prepared LiFePO₄.

For electrochemical characterization, electrodes were prepared on aluminum foil. LiFePO₄, without carbon coating, super-P carbon black, and polyvinylidene difluoride (PVDF) in the weight ratio of 55:30:15 were mixed in a solution of N-methyl-2-pyrrolidinone (NMP) to form slurry. The slurry was then spread onto an aluminum foil, using a doctor blade to form one or more positive electrodes (cathodes). The electrodes were dried at 100° C. overnight under vacuum. The electrochemical measurements were made with a 2026 coin cell. The cell was soaked in 1.0M LiPF₆ in ethylene carbonate and dimethyl carbonate (50:50 in volume) electrolyte. The assembled 2026 coin cell was cycled between 2.0 V and 4.4 V at room temperature.

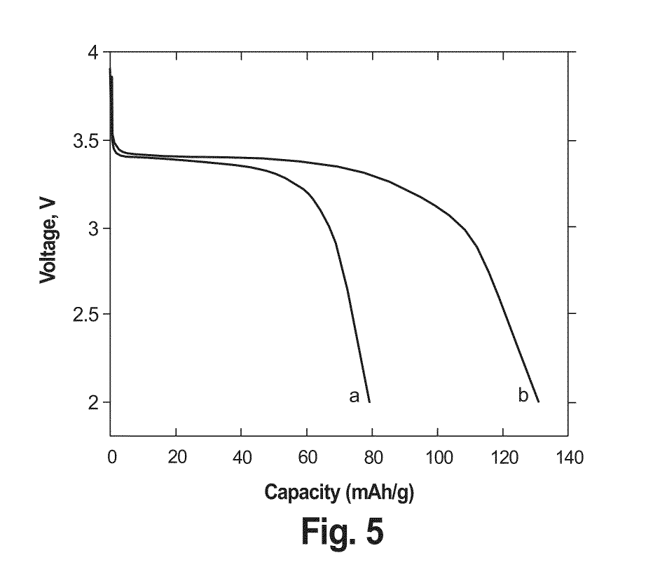

FIG. 5 show the results of an electrochemical study on the assembled 2026 coin cell made with LiFePO₄ compound before and after heat treatment at 500° C. The results, as shown in FIG. 5, demonstrate a significant improvement in the performance of the defect-free material, with the specific capacity increasing from 80 to 130 mAh/g at a rate of C/20. This result confirms that the presence of antisite defects (specifically, iron on lithium sites) limits lithium diffusion and reduces the electrochemical performance of the material.

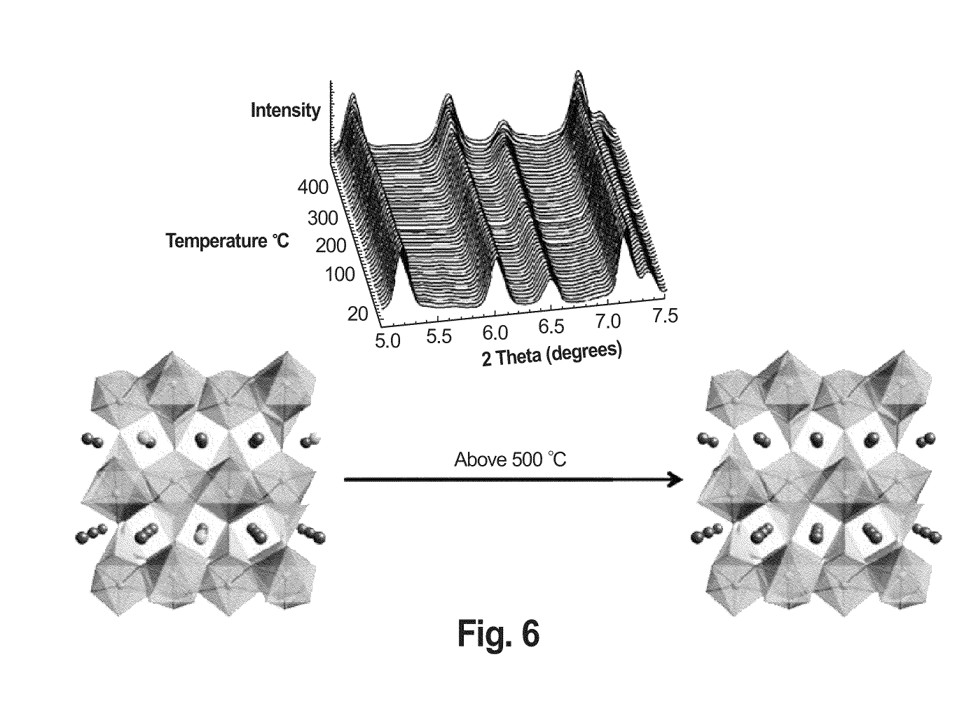

Thus, the concentration of antisite defects in hydrothermally prepared LiFePO₄ was investigated as a function of the temperature by in situ high-resolution XRD. The amount of cation disorder was reduced as the temperature of the heat treatment was increased. As shown in FIG. 6, the antisite defects were completely eliminated at 500° C. This suggests the post synthesis heat treatment at or around the transition temperature in an inert atmosphere (e.g., helium, nitrogen, argon, etc.) is effective at reducing iron and lithium exchange, thereby producing defect-free phospho-olivine compound(s). These results also demonstrate that intrinsic structural defects in cathode materials can be monitored by in situ high-resolution synchrotron XRD. High-resolution X-ray diffraction not only is a method for measuring lattice constants but also is useful for accurately determining the site occupancy. The site occupancy is critically important in cathodes with tunnel or layered structures where lithium-ion transport is often restricted by a small amount of disorder.

### Example 10

To study the formation of olivine LiFePO₄, a sealed quartz tube shown in FIG. 7 was developed to serve as an in situ hydrothermal reactor. Ferrous sulfate (0.695 g), 1 M phosphoric acid (˜2.5 ml) and lithium hydroxide (0.315 g) were mixed together to form a greenish slurry, which was immediately injected into the quartz capillary. A high-resolution XRD pattern was acquired immediately after injection at 30° C. The precursor phase was clearly indexed as Fe₃(PO₄)2.8H₂O, vivianite (PDF#30-0662). Rietveld refinement of the powder X-ray diffraction pattern indicated it was monoclinic, C12/ml space group, with a=10.1028(3) Å, b=13.4392(5) Å, c=4.7104(1) Å, a cell volume of 619.72(4) Å3, and α=90°, β=104.304(2)°, γ=90°.

### Example 11

To explore the mechanism of the LiFePO₄ formation in a time resolved manner, successive diffraction patterns were taken every minute. Quantitative growth and decay curves were determined from analyzing the integrated Bragg peak intensities of the reactants and the products. The peak intensities were extracted using an automated pseudo-Voigt profile-fitting routine from the Jade Software package (Material Data Inc. Livermore, Calif.). In the reactions carried out at 105° C. (shown in FIG. 8), the precursor peaks gradually decrease, disappearing after only ˜17 minutes, suggesting complete dissolution of the vivanite. The formation of crystalline LiFePO₄ is initially detected ˜5 minutes after the precursor peak intensities begin to decline. The integrated intensity of LiFePO₄ peaks continues to rise over the next 30 minutes and then remains essentially constant through the remainder of the experiment. This experiment was repeated at 115° C.

### Example 12

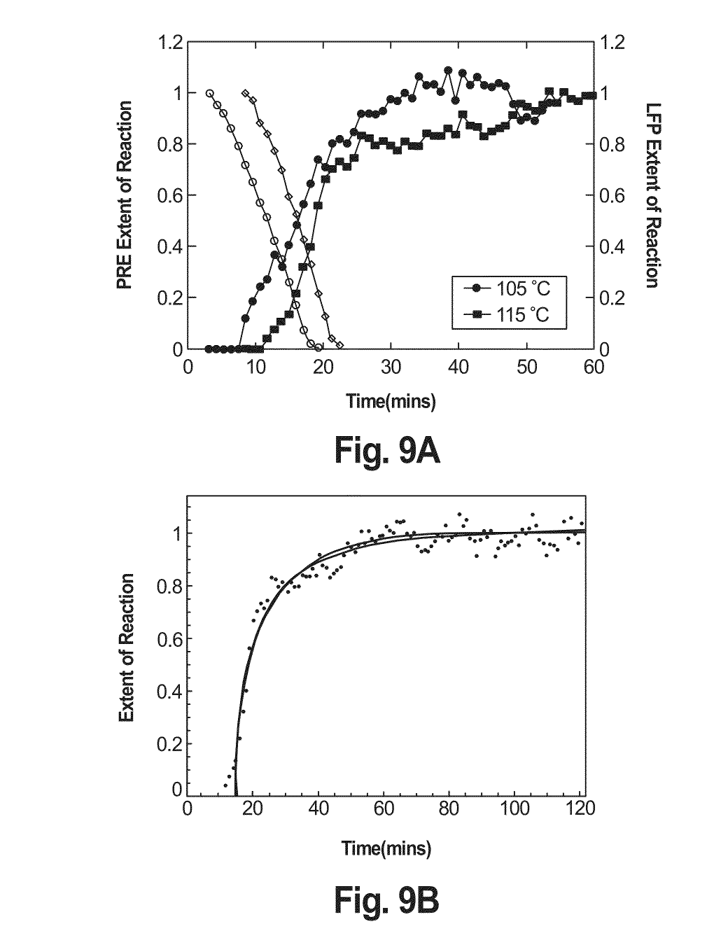

FIG. 9A shows the decay curve of the vivianite precursor and FIG. 9B shows the crystallization curves for the formation of LiFePO₄ at 105° C. and 115° C. After correcting for small changes in the incubation time (time of first detection of crystalline product), and accounting for fluctuations in the measured intensities, the rate of LiFePO₄ formation at the two different temperatures are found to be very similar as illustrated in FIG. 9C. The data obtained from the reaction at 115° C. was fit to the Avrami-Erofe'ev equation, α=1−exp[−(k(t−t₀)ⁿ)], where to is the induction time for crystallization, k is the rate constant, and n is the Avrami exponent.

The best fit was achieved with an exponent of n ˜0.58, although a slight deviation from this form is visible during the first few minutes of LiFePO₄ formation (see FIG. 9B). The Avrami exponent (n) was also calculated from a Sharp-Hancock plot, which gave a value of n=0.64. Values of n<1 are not consistent with classical Avrami kinetics involving simultaneous nucleation of new particles and n-dimensional growth of existing particles, both at a uniform rate. It has been demonstrated mathematically in Francis et al., 1999, J Am Chem Soc 121:1002-1015 that particle growth limited purely by 3-D diffusion mimics the Avrami-Erofe'ev model with n=0.57.

In the same work, the hydrothermal synthesis of microporous gallophosphate showed a weak dependence of the kinetic constants on the reaction temperature over a range of 10-20° C. (similar to our own observations), and the best fit was achieved with an exponent of n ˜0.45. Based on these similarities, the 115° C. crystallization data was fit using a 3-D diffusion-limited growth model [1−(1−α)^{1/3}]²=k(t−t₀) from t₀=14.8 s until t=5418 s (see FIG. 9B). On the basis of the high quality of the fit (R²=0.9974), it is reasonable to conclude that a 3-D diffusion-controlled process likely limits the formation of LiFePO₄ and the formation of LiFePO₄ occurs by a typical dissolution-recrystallization process during hydrothermal synthesis.

Typically, the crystallization rate of a 3-D diffusion-controlled reaction is determined by how quickly species are transported to the nucleation sites. Once nucleation has occurred, the rate of crystallization is determined only by the rate at which species in solution can diffuse onto the nucleation site. This suggests that vigorous stirring should effectively speed up the diffusion during the reaction and possibly enhance the crystallization process of LiFePO₄. Since the formation of LiFePO₄ occurs by direct precipitation at elevated temperature, crystal growth techniques that rely on manipulating of the saturation limit to control particle size may not be effective. The slow cooling of the liquid is unlikely to yield larger LiFePO₄ crystallites because the crystallization is already complete at the elevated temperature (before cooling)).

At reaction temperatures of 100° C. and higher, both the dissolution of the precursor and the precipitation of the products is rapid, resulting in the transformation of vivianite to lithium iron phosphate over several minutes. At lower temperatures (e.g., 95° C. and below) the diffraction patterns indicate that the vivianite precursor is not completely dissolved even after a few hours. These data also indicate the complete absence of crystalline LiFePO₄, but rather the formation of a side product.

### Example 13

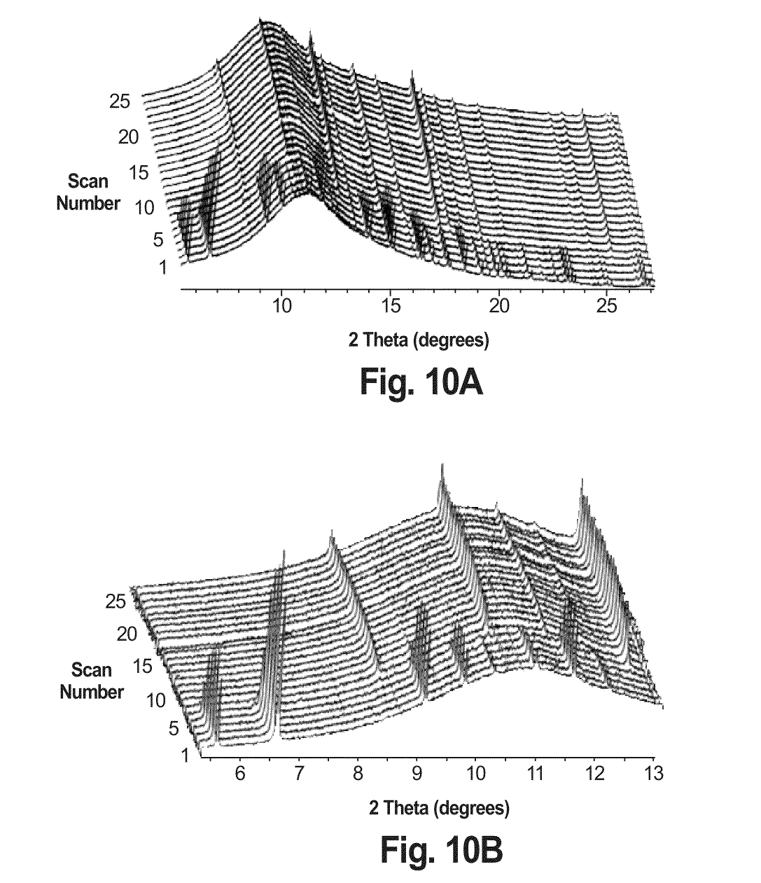

A series of experiments were performed at higher temperatures to study changes in the crystallographic structure. First, after injecting the precursor into the capillary tube, the solution was quickly heated at a rate of about 4° C./min from room temperature up to 155° C., and held for 45 minutes. Then, the temperature was raised to 178° C., and held for 84 minutes. In the third step, the temperature was increased to 195° C. and held for 40 minutes. Finally, the temperature of the sample was raised to ˜210° C., and held 40 minutes. X-ray diffraction patterns were recorded continuously after the sample temperature reached 100° C. as illustrated in FIGS. 10A and 10B. (the time-resolved XRD patterns from 100° C. to 160° C. at 3.5 mins/scan).

As the temperature rises from 100° C., the intensity of the characteristic Bragg peaks from the vivianite precursor (2θ=5.6° (110) reflection and, 6.6° (020) reflection) fall sharply. The peaks from LiFePO₄ appear and gradually increase during this stage, implying the co-existence of both the vivianite and tryphylite phases. At approximately 130° C. the characteristic diffraction peaks from vivianite have completely disappeared and only the peaks from LiFePO₄ are evident, indicating the solid precipitate is pure LiFePO₄.

The high angular resolution (0.005°/step) of the diffraction data obtained are well suited to Rietveld refinement analysis, which was performed for the LiFePO₄ patterns acquired from 155° C. to 210° C. All of the diffraction peaks shift to higher angles when the temperature is increased from 155° C. to 178° C., indicating a decrease of the unit cell dimensions. The initial lattice parameters of LiFePO₄ at 155° C. were a=10.3632(5) Å, b=6.0030(3) Å, c=4.7147(2) Å with a cell volume of 293.30(4) Å³. The refinement was terminated at reliability values of R_{wp} =1.37% and Rₚ=1.03%. At 178° C. the lattice parameters (before temperature soak) were a=10.3515(3) Å, b=6.0119(2) Å, c=4.7060(1) Å with a cell volume of 292.87(2) Å³. The refinement was terminated at a reliability of R_{wp}=1.66% and Rₚ=1.32%.

### Example 14

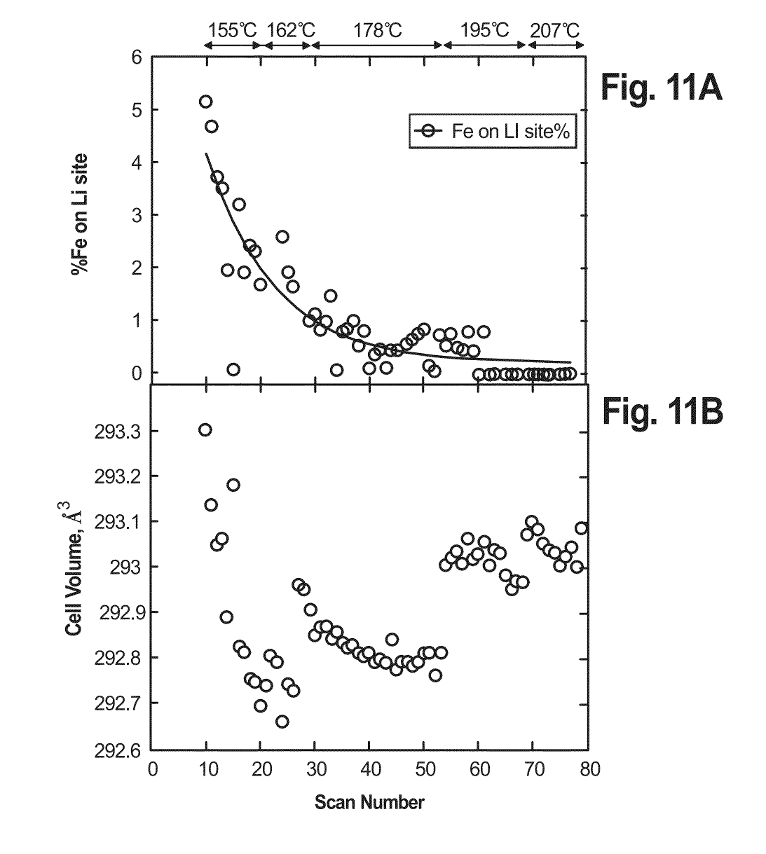

The time-resolved crystallographic information, including the cell volumes and the anti-site defect concentration (Fe on Li sites) determined from Rietveld refinement, are shown in FIGS. 11A and 11B. The concentration of anti-site defects as a function of the hydrothermal reaction temperature is shown in FIG. 11A. The average of the standard deviation of these refined atomic occupancies is around 0.4%. The onset of cation ordering occurs at around 155° C. with an initial concentration of Fe on Li sites of 5.14%. The anti-site defect concentration drops by ˜1.7% after holding at 155° C. for about 45 minutes. The concentration of iron on lithium sites continues to decline with increasing temperature. At 178° C. (before holding), the defect concentration is about 1% and this value drops to between 0.5% and 0.8% after holding at this temperature for 40 minutes. The number of ant-site defects abruptly drops to zero when the temperature reaches ˜195° C., even without the temperature soak.

Normally, when heated, LiFePO₄ exhibits an increase in the unit cell dimensions due to thermal expansion; however, here the opposite effect was observed. The data reveals a competition between thermal expansion and cation ordering, which results in a contraction of the unit cell. The lattice parameters of LiFePO₄ at 210° C. before holding were a=10.3519(2) Å, b=6.0153(2) Å, c=4.7060(1) Å with a cell volume of 293.04(2) Å³. The refinement was terminated at a reliability of R_{wp}=1.81% and Rₚ=1.43%. As shown in FIG. 11B, the majority of the anti-site defects were eliminated at temperatures between 155° C. and 178° C. Thus, the cell volume decreased due to the elimination of anti-site defects offsetting the thermal expansion. At temperatures from 180° C. to 210° C., less than 0.5% iron disorder was removed and a nearly defect-free material was obtained when the sample reached ˜195° C. After almost all of the anti-site defects were removed, the thermal expansion dominates and the unit cell dimensions increased after scan #53. Once the sample was allowed to cool down to 40° C. the final lattice parameters were a=10.3319(1) Å, b=6.0040(1) Å, c=4.6939(1) Å with a cell volume of 291.18(1) Å³. The reliability factors for this fit were R_{wp}=1.41% and Rₚ=0.95%. The unit cell volume is consistent with the cell volume in defect-free LiFePO₄ (no iron on lithium sites) at room temperature, which is typically 290-291.4 Å³.

All publications and patents mentioned in the above specification are herein incorporated by reference in their entireties. Various modifications and variations of the described materials and methods will be apparent to those skilled in the art without departing from the scope and spirit of the invention. Although the disclosure has been described in connection with specific preferred embodiments, it should be understood that the invention as claimed should not be unduly limited to such specific embodiments. Indeed, those skilled in the art will recognize, or be able to ascertain using the teaching herein and no more than routine experimentation, many equivalents to the specific embodiments of the invention described herein. Such equivalents are intended to be encompassed by the following claims.

1. A method of synthesizing a defect-free phospho-olivine, comprising:
providing an aqueous solutions of Li⁺, Mⁿ⁺, and PO₄³⁻ in a reactor, wherein Mⁿ⁺ is one or more single or a mixed transition metal selected from the group consisting of Fe²⁺, Fe³⁺, Mn²⁺, Co²⁺, Ni²⁺, Mg²⁺, and Zn²⁺;
heating the solution in the reactor to about 100° C. to 350° C. under elevated pressure of 100-3000 psi for about 1 to 16 hours to produce a phospho-olivine crystal lattice having a formula
LiₓMPO₄
where 0<x≦1, with varying degree of defects due to a presence of M-type metal in lithium sites of the phospho-olivine structure;
recovering the produced phospho-olivine as a powder; and
heating the phospho-olivine powder to a transition temperature in an inert or reducing atmosphere, thereby forming a defect-free phospho-olivine structure.

2. The method according to claim 1, wherein the defect-free phospho-olivine structure has less than about 2% defects.

3. The method according to claim 2, wherein the defect-free phospho-olivine structure has less than about 0.5% defects.

4. The method according to claim 1, wherein the phospho olivine crystal lattice has a Pnma space group.

5. The method according to claim 1, further comprising determining the transition temperature for defect elimination in the phospho-olivine crystal lattice by in situ X-ray diffraction.

6. The method according to claim 1, further comprising adding a reducing agent to the aqueous solution of Li⁺, Mⁿ⁺, and PO₄³⁻ to minimize Mⁿ⁺ oxidation.

7. The method according to claim 6, wherein the reducing agent is selected from the group consisting of L-ascorbic acid, sucrose, hydrazine, citric acid, and a combination thereof.

8. The method according to claim 1, wherein the reactor is an autoclave.

9. The method according to claim 8, wherein the autoclave is a Parr reactor.

10. The method according to claim 1, wherein Li⁺ is selected from the group consisting of LiOH, Li₂SO₄, LiH₂PO₄ and Li₂CO₃, PO₄³⁻ is selected from the group consisting of H₃PO₄ and NH₄H₂PO₄, Fe²⁺ is selected from the group consisting of FeSO₄.7H₂O, FeCl₂.4H₂O, FeC₂O₄, and FeCl₂, Fe³⁺ is Fe(NO₃)₃, Mn²⁺ is selected from the group consisting of MnSO₄.H₂O, Mn(NO₃)₂, and MnCl₂, Co²⁺ is selected from the group consisting of CoSO₄.7H₂O, CoCl₂.6H₂O, and Co(NO₃)₂, Ni²⁺ is selected from the group consisting of NiSO₄, Ni(NO₃)₂ and NiCl₂, Mg²⁺ is selected from the group consisting of MgSO₄, Mg(NO₃)₂, and MgCl₂, and Zn²⁺ is selected from the group consisting of ZnSO₄, Zn(NO₃)₂, and ZnCl₂.

11. The method according to claim 1, wherein the transition temperature for defect elimination of the lithium iron phospho-olivine powder (LiFePO₄) is about 450° C. to about 500° C.

12. A method of manufacturing a defect-free phospho olivine based lithium insertion-type electrode, comprising:
providing an aqueous solutions of Li⁺, Mⁿ⁺, and PO₄³⁻ in a reactor, wherein Mⁿ⁺ is one or more single or a mixed transition metal selected from the group consisting of Fe²⁺, Fe³⁺, Mn²⁺, Co²⁺, Ni²⁺, Mg²⁺, and Zn²⁺;
heating the solution in the reactor to about 150° C. to 220° C. under elevated pressure 100-3000 psi for about 3 to 10 hours to produce a phospho-olivine having a formula LiMₓPO₄ where 0<x≦1, with varying degree of defects due to a presence of M metal in lithium sites of the phospho-olivine structure;
recovering the produced phospho-olivine as a powder;
heating the phospho-olivine powder to a transition temperature in an inert or reducing atmosphere, thereby forming a defect-free phospho-olivine structure, and
mixing the defect-free phospho-olivine with a conducting additive to produce the defect-free phospho olivine based lithium insertion-type electrode.

13. The method according to claim 12, further comprising determining the transition temperature for defect elimination in the phospho-olivine crystal lattice by in situ X-ray diffraction.

14. The method according to claim 12, further comprising adding a binder to the combination of the defect-free phospho-olivine and the conducting additive.

15. The method according to claim 14, wherein the conducting additive is a conducting carbon.

16. A defect-free phospho-olivine composition prepared by a process, comprising: providing an aqueous solutions of Li⁺, Mⁿ⁺, and PO₄³⁻ in a reactor, wherein Mⁿ⁺ is one or more single or a mixed transition metal selected from the group consisting of Fe²⁺, Fe³⁺ Mn²⁺, Co²⁺, Ni²⁺, Mg²⁺, and Zn²⁺;
heating the solution in the reactor to about 150 to 220° C. under elevated pressure 100-3000 psi for about 3 to 10 hours to produce a phospho-olivine having a formula LiMₓPO₄ where 0<x≦1, with varying degree of defects due to a presence of M metal in lithium sites of the phospho-olivine structure;
recovering the produced phospho-olivine as a powder; and
heating the phospho-olivine powder to a transition temperature in an inert or reducing atmosphere, thereby forming the defect-free phospho-olivine structure.

17. The defect-free phospho-olivine composition according to claim 16, wherein the defect-free phospho-olivine structure has less than about 2% defects.

18. The defect-free phospho-olivine composition according to claim 17, wherein the defect-free phospho-olivine structure has less than about 0.5% defects.

19. The defect-free phospho-olivine composition according to claim 16, where the phospho-olivine forms a crystal lattice having a Pnma space group.

20. The defect-free phospho-olivine composition according to claim 16, wherein the transition temperature for defect elimination in the phospho-olivine crystal lattice is determined by in situ x-ray diffraction.

21. A lithium insertion-type electrode comprising the defect-free phospho-olivine according to claim 16, a conducting additive and a binder.

22. A battery comprising the lithium insertion-type electrode of claim 21, a negative electrode and an electrolyte.

23. A method of synthesizing a defect-free phospho-olivine composition, comprising:
providing a slurry of Li⁺, Mⁿ⁺, and PO₄³⁻ in a one-pot in-situ reactor, wherein Mⁿ⁺ is one or more single or a mixed transition metal selected from the group consisting of Fe²⁺, Fe³⁺, Mn²⁺, Co²⁺, Ni²⁺, Mg²⁺, and Zn²⁺;
heating the slurry in the reactor to about a first reaction temperature where a phospho-olivine crystal lattice having a formula LiₓMPO₄ where 0<x≦1, with varying degree of defects due to a presence of M-type metal in lithium sites forms under autogenous pressure;
heating the formed phospho-olivine crystal lattice in the reactor to about a second reaction temperature, which defines the onset of cation ordering;
holding the second reaction temperature until a desired defect concentration is reached; and
recovering the produced defect-free phospho-olivine.

24. The method according to claim 23, further comprising determining the first reaction temperature for crystal growth in the phospho-olivine crystal lattice and the second reaction temperature for defect elimination in the phospho-olivine crystal lattice by in situ X-ray diffraction.

25. The method according to claim 24, wherein the crystal growth in the phospho-olivine crystal lattice is determined based on characteristic Bragg peaks detected by the in situ X-ray diffraction.

26. The method according to claim 24, wherein the onset of cation ordering in the phospho-olivine crystal lattice is determined based lattice parameters detected by the in situ X-ray diffraction.

27. The method according to claim 24, wherein the first reaction temperature is about 105° C. to about 210° C.

28. The method according to claim 24, wherein the second reaction temperature is about 155° C. to about 210° C.

29. The method according to claim 24, wherein the first reaction temperature and the second reaction temperature are the same or similar.

30. The method according to claim 24, further comprising adding a reducing agent to the aqueous solution of Li⁺, Mn⁺, and PO₄³⁻ to minimize Mⁿ⁺ oxidation.

31. The method according to claim 30, wherein the reducing agent is selected from the group consisting of L-ascorbic acid, sucrose, hydrazine, citric acid, and a combination thereof.

32. The method according to claim 23, wherein Li⁺ is selected from the group consisting of LiOH, Li₂SO₄, LiH₂PO₄ and Li₂CO₃, PO₄³⁻ is selected from the group consisting of H₃PO₄ and NH₄H₂PO₄, Fe²⁺ is selected from the group consisting of FeSO₄.7H₂O, FeCl₂.4H₂O, FeC₂O₄, and FeCl₂, Fe³⁺ is Fe(NO₃)₃, Mn²⁺ is selected from the group consisting of MnSO₄.H₂O, Mn(NO₃)₂, and MnCl₂, Co²⁺ is selected from the group consisting of CoSO₄.7H₂O, CoCl₂.6H₂O, and Co(NO₃)₂, Ni²⁺ is selected from the group consisting of NiSO₄, Ni(NO₃)₂ and NiCl₂, Mg²⁺ is selected from the group consisting of MgSO₄, Mg(NO₃)₂, and MgCl₂, and Zn²⁺ is selected from the group consisting of ZnSO₄, Zn(NO₃)₂, and ZnCl₂.

33. A method according to claim 24, wherein the method further comprises
monitoring the slurry in the reactor by in situ x-ray diffraction during the heating of the slurry to determine the first reaction temperature; and
monitoring an onset of cation ordering in the formed phospho-olivine crystal lattice by in situ x-ray diffraction to determine the second reaction temperature.

34. A method of manufacturing a defect-free phospho-olivine based lithium insertion-type electrode, comprising:
mixing the defect-free phospho-olivine prepared according to claim 23 with a conducting additive to produce the defect-free phospho olivine based lithium insertion-type electrode.

35. The method according to claim 34, further comprising adding a binder to the combination of the defect-free phospho-olivine and the conducting additive.

36. The method according to claim 35, wherein the conducting additive is a conducting carbon.

37. A defect-free phospho-olivine composition prepared by a process, comprising:
providing a slurry of Li⁺, Mⁿ⁺, and PO₄³⁻ in a one-pot in-situ reactor, wherein Mⁿ⁺ is one or more single or a mixed transition metal selected from the group consisting of Fe²⁺, Fe³⁺, Mn²⁺, Co²⁺, Ni²⁺, Mg²⁺, and Zn²⁺;
heating the slurry in the reactor under autogenous pressure;
monitoring the slurry in the reactor by in situ x-ray diffraction to determine a first temperature where a phospho-olivine crystal lattice having a formula LiₓMPO₄ where 0<x≦1 forms;
heating the formed phospho-olivine crystal lattice in the reactor;
monitoring the formed phospho-olivine crystal lattice in the reactor by in situ x-ray diffraction to determine an onset of cation ordering;
holding the temperature until a desired defect concentration is reached; and
recovering a defect-free phospho-olivine.

38. A lithium insertion-type positive electrode comprising the defect-free phospho-olivine according to claim 37, a conducting additive and a binder.

39. A battery comprising the lithium insertion-type electrode of claim 38, a negative electrode and an electrolyte.
